(19) United States
(12) Patent Application Publication
(10) Pub. No.: US 2021/0102893 A1
(43) Pub. Date: Apr. 8, 2021

(54) TRANSMISSIVE SCATTERING FOR RADIOMETRY

(71) Applicant: Halliburton Energy Services, Inc., Houston, TX (US)

(72) Inventors: Jian Li, Bellaire, TX (US); Bin Dai, Spring, TX (US); Christopher Michael Jones, Katy, TX (US); James M. Price, Cypress, TX (US)

(21) Appl. No.: 16/595,591

(22) Filed: Oct. 8, 2019

(51) Int. Cl. G01N 21/47; G01N 21/93

(52) U.S. Cl. CPC G01N 21/47; G01N 2021/4764; G01N 21/93

(57) ABSTRACT

Systems and procedures for implementing radiometric calibration are disclosed. In some embodiments a radiometry system includes a light source that generates light. The radiometry system further includes a transmissive diffuser configured to receive the light and comprising a first translucent element having a surface and/or internal diffusion structure that substantially scatters the light. An optical detector is configured to receive and detect diffused light from the transmissive diffuser.

### BACKGROUND

The disclosure generally relates to the field of radiometry and more particularly to techniques and structures for diffusing light energy for optical measurements.

Radiometry generally entails measuring electromagnetic radiation to determine characteristics of the radiation's distribution in space. Spectral analysis of light energy is an example of radiometry that has a variety of practical commercial and academic applications. For petroleum exploration, extraction, and processing applications, radiometric analysis may be utilized in situ (underground or otherwise in the field) to identify various fluid components within oil or gas samples.

Optical radiometry systems, or optical systems, utilized for downhole sample measurements typically include several components within an optical measurement path. In addition to a light source and sample light detector, the optical system may include a sample containment component such as a transparent portion of a conduit through which sample fluid material flows or is otherwise contained. The source light reaches sample fluid material through the transparent portion of the conduit and resultant sample-interacted light propagates from the transparent portion to be received by the optical detector. The optical system may further include spectral selection components such as a spectral filter device that selectively transmits a narrow band of wavelengths of the sample-interacted light to the detector.

Calibration of each of the optical system components may be utilized to determine the input-dependent operating parameters of others of the components as well as the operational/performance parameters of the overall optical system. Prior to field deployment, optical system components may be initially characterized to determine operating parameter baselines for the system. A common optical characterization technique utilizes reference components, such as a reference light source and/or a reference detector, in combination with other reference components and/or non-reference components to determine performance data used for characterizing the non-reference componence such as for calibrating a sample detector. A typical sequence of reference characterization scans may include a background response scan in which the optical response data is collected for an optical system that includes a reference light and a reference detector. Following the background scan, the reference detector may be replaced by the to-be-calibrated downhole detector and response data measured and recorded using the reference light source. The performance data derived at least in part from the reference components is utilized in combination with performance data derived from the non-reference components to characterize optical system components, such as the downhole detectors.

The reference characterization technique is susceptible to error caused by inevitable differences in the optical path alignments between each of the sequence of characterization scans. Some optical systems use a light scatterer/diffuser to reduce error caused even by minute alignment differences between successive, differently configured optical paths. For example, a reflective component such as an integrating sphere may be included in each of the calibration optical paths to provide a diffused light source that mitigates the alignment induced errors.

### BRIEF DESCRIPTION OF THE DRAWINGS

Embodiments of the disclosure may be better understood by referencing the accompanying drawings.

FIG. 1 is a block diagram depicting a radiometry system in accordance with some embodiments;

FIG. 2 is a block diagram illustrating a radiometry system in accordance with some embodiments;

FIG. 3 is a block diagram depicting a radiometry system in accordance with some embodiments;

FIGS. 4A and 4B illustrate transmissive diffusers that may be utilized in a radiometry system in accordance with some embodiments;

FIGS. 5A and 5B depict transmissive diffusers that may be utilized in a radiometry system in accordance with some embodiments;

FIG. 6 illustrates a drilling system in accordance with some embodiments;

FIG. 7 depicts a wireline logging system in accordance with some embodiments; and

FIG. 8 is a flow diagram illustrating operations and functions for characterizing optical components and utilizing the characterized optical components for downhole fluid sampling and measurements in accordance with some embodiments.

### DESCRIPTION

The description that follows includes example systems, methods, techniques, and program flows that embody aspects of the disclosure. However, it is understood that this disclosure may be practiced without one or more of these specific details. In other instances, well-known instruction instances, protocols, structures and techniques have not been shown in detail in order not to obfuscate the description.

### Overview

Disclosed embodiments include a radiometry system configured for performing radiometric characterization and calibration operations. A radiometry system for performing radiometric calibration may include reference radiometric components such as a reference light source and a reference optical detector. The reference light source and optical detector are installed and operated in an optical measurement path to collect reference source and/or reference detector information. The radiometry system may further include field optical components to be calibrated and/or to be characterized and used for calibrating other components. The field components may include a field light source and a field optical detector. The field light source and field optical detector are installed and operated in an optical measurement path to collect sample light source and/or sample optical detector information. The accuracy and other operating parameters of the components within the optical measurement path may drift over time based on usage wear and other factors. In particular, the performance of light sources and optical detectors may be particularly susceptible to performance variation over usage periods.

On-site field calibration/re-calibration may be utilized to determine and correct for such performance variations in a testing environment having limited space and equipment. As for other optical calibration techniques, such as in laboratory, on-site field calibration of an optical measurement system entails testing the performance of components such as light sources and optical detectors. A reference-based calibration test may be utilized in which an optical detector measures light energy (light), such as infrared, ultraviolet, as well as visible light, originating from the light source. Multiple measurement cycles are performed including a baseline cycle in which a reference light source and/or reference optical detector are utilized to obtain a reference baseline result. Following the baseline cycle, one or more of the reference components (e.g., reference light source) are replaced by test components (e.g., test light source) in the optical measurement path to measure or otherwise determine test component performance. The test components performance data is then processed in association with the reference components performance data to calculate or otherwise determine the current performance metrics for the test components that can be utilized to calibrate the overall optical measurement system to be deployed.

The high-precision measurements and the calculations determining differences between the measurements requires consistency between calibration measurement cycles to ensure that inter-cycle measurement variability is limited to the differences between reference component performance and test component performance. Most practical optical measurement paths used either on-site or in more controlled environments such as a laboratory cannot prevent at least minute differences in alignment of components in the optical measurement path between measurement cycles. To eliminate or at least reduce the distortion in calibration test measurements resulting from misalignment, disclosed embodiments include a transmissive diffuser that scatters/diffuses light such transmitted from the light source. The diffusion of the light prior to reaching the optical detector substantially reduces the system's sensitivity, such as may manifest in optical detector responses, to component alignment within the optical measurement path.

### Example Illustrations

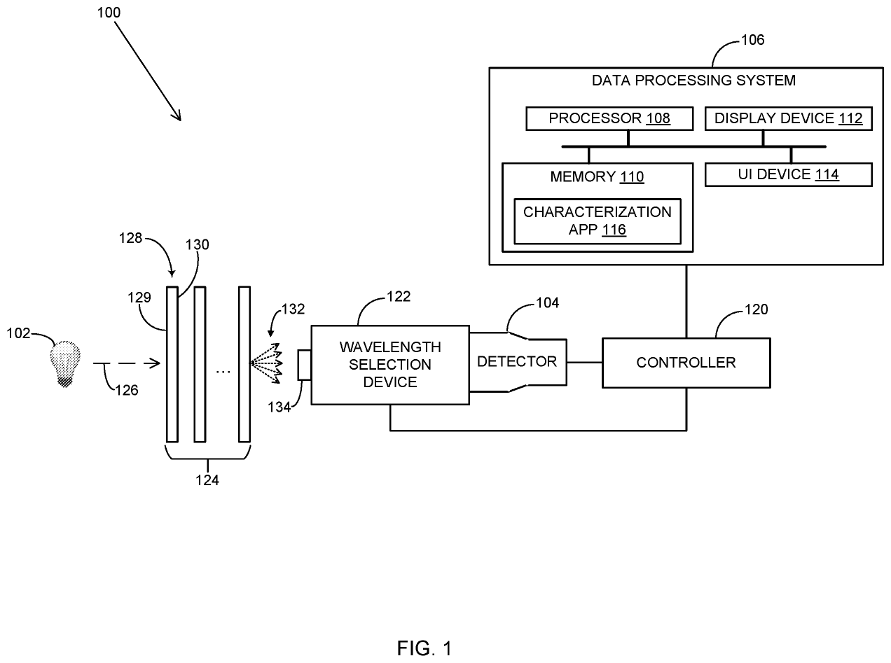

FIG. 1 is a block diagram depicting a radiometry system 100 in accordance with some embodiments. Radiometry system 100 includes sub-systems, devices, and components configured to implement characterization and related calibration techniques applicable to components and systems that implement electromagnetic (EM) radiation measurement operations. EM radiation measurement operations performed by components tested by radiometry system 100 may include spectroscopic analysis of how EM radiation interacts with various types of matter. Spectroscopic analysis may be performed on formation materials and fluids by deploying an optical measurement system downhole and/or may be implemented in a surface field test site in which the optical measurement system measures spectral transformation properties of solids and/or fluids sampled downhole and transported to the surface field test site. The range of EM radiation included in optical measurements used for spectroscopic analysis is typically EM “light” radiation, including visible, infrared, and ultraviolet spectra, collectively referred to as light energy, light waves, light, optical waves, optical energy, etc.

Radiometry system 100 is configured to determine and compare performance metrics for one or more test components (i.e., components to be deployed in an optical measurement system) and one or more corresponding reference components (i.e., components having known operational parameters). As utilized herein a test component may be referred to as an “uncharacterized” component and a reference component as a “characterized” component. Radiometry system 100 may be configured to measure performance values for a component under test (e.g., a test optical detector) that correspond to input from a reference component (e.g., a reference light source) and input from another test component (e.g., a test light source). The sequence of measurements performed by radiometry system 100 are utilized to quantify performance degradation of the test components over periods of usage in the field.

An optical train within radiometry system 100 includes an interchangeable light source 102 that generates and transmits EM light radiation that is detected by an optical detector 104. Light source 102 may comprise a broad-spectrum or narrow-spectrum source that generates light 126 in the visible, infrared, or ultraviolet spectra ranges. light, such as light 126, generally refers to non-scattered/non-diffused light transmitted from a point source such as light source 102. Example implementations of light source 102 include electroluminescence sources such as an electroluminescent lamp, laser, LED, etc. Light source 102 is interchangeable in terms of comprising either a test light source or a reference light source, depending on the optical measurement cycle within an overall calibration sequence.

Optical detector 104 is configured to generate response signals corresponding to metrics such as intensity and/or frequency of light energy originating from light source 102 and propagating through the optical train until being received by optical detector 104. Like light source 102, optical detector 104 is interchangeable in terms of comprising either a test optical detector or a reference optical detector, depending on the optical measurement cycle within an overall calibration sequence. In some embodiments, optical detector 104 may include a photoreactive component such as a photodiode that converts light energy into electrical current. Optical detector 104 may also or alternatively include other types of optical transducer components such as a photo-acoustic detector, a piezo-electric detector, a charge coupled device detector, a photon detector, and any combination thereof. In response to receiving/detecting light energy, optical detector 104 generates corresponding response signals that are transmitted to a data processing system 106 such as via a controller 120.

During and/or following optical measurement cycles, detector response information from optical detector 104 is processed by data processing system 106 to determine and compare performance metrics of one or more of the components, including light source 102 and optical detector 104 within the optical measurement path. For instance, data processing system 106 may comprise processing components configured to derive characterization values such as calibration coefficients from the raw and/or pre-processed detector response data.

Data processing system 106 includes a memory device 110 into which components of a characterization application 116 are loaded and a processor 108 for executing instructions to implement operations and functions encoded in characterization application 116. Characterization application 116 includes program instructions configured to determine characterization values such as calibration coefficients based on response information received from optical detector 104 over one or more optical measurement cycles. Data processing system 106 may further include a user input device 114 that may be used individually or in conjunction with a display device 112 to input instructions and provide intermediary results data from the measurement and characterization processes.

Some field optical measurement systems are configured to detect spectral results that may be determined, at least in part, by the use of optical filter components that selectively remove particular spectral components. Therefore, the information required to determine optimally comprehensive characterization values may require responses generated by optical detector 104 having a similar spectral selectivity. In the depicted embodiment, the optical train includes a wavelength selection device 122 positioned at the input of optical detector 104. Wavelength selection device 122 is configured to selectively pass/reject one or more wavelength components of light energy received by wavelength selection device 122. In some embodiments, wavelength selection device 122 may be a monochromator that includes a wavelength/frequency selective filter that filters the light energy to provide a monochromatic spectral output to optical detector 104. The spectral output comprises light energy components within a spectral range determined in accordance with the design, configuration, and settings of wavelength selection device 122.

Characterizing an optical system and/or components within the optical system may entail measuring field/test component performance based on optical responses generated by detector 104. For some measurement cycles in which the performance of one or more components of the optical system is measured, a test light source (i.e., uncharacterized light source) may be utilized as light source 102 and a reference detector (i.e., characterized detector) may be utilized as optical detector 104. For other measurement cycles in which the performance of one or more components of the optical system is measured, a reference (i.e., characterized) light source is utilized as light source 102 and a test (i.e., uncharacterized) detector is utilized as optical detector 104. Optical system component performance metrics are compared across measurement cycles to determine characterization values such as calibration coefficients. To determine the test component performance metrics in a manner that the results may be utilized for calibration, the performance metrics may be normalized such as by comparing test component performance with performance metrics of reference components. For instance, radiometry system 100 may be configured to implement sequences of optical measurement cycles using corresponding combinations of test and/or reference components in the optical train.

Externally induced variations in optical characterization metrics are minimized by utilizing a consistently configured optical measurement path between measurement cycles. The absolute and relative positioning of the optical components within an optical train are substantially (to the extent practicable) the same between measurement cycles. However, between measurement cycles one or more optical train components such as light source 102, optical detector 104, and/or other components not depicted may be replaced. For example, light source 102 may be a reference light source that is replaced with a test light source and similarly for optical detector 104. Since replacing even a single component in the optical train may alter alignment of portions of the measurement path, a transmissive diffuser may be included in the optical train to at least partially negate the effects of differing alignments on light energy such as generated by light source 102.

In the depicted embodiment, the optical train of radiometry system 100 includes an in-line, transmission-based diffusion component in the form of a transmissive diffuser 124. Transmissive diffuser 124 is configured to include one or more transmissive scattering boundaries through which light 126 is diffused as it propagates toward optical detector 104. The diffusion path is in alignment with the original propagation direction of the light 126 in the depicted configuration in which light source 102, transmissive diffuser 124, and optical detector 104 are axially aligned. In some embodiments, such as during operation of radiometry system 100, substantial diffusion of light 126 may be achieved by material composition and other structural aspects of transmissive diffuser 124 that results in light 126 being scattered while propagating through transmissive diffuser 124. The transmissive diffusion may result in substantially lower energy losses that may occur for reflective type light scattering devices such as integrating spheres. For example, the lossy reflections within an integrating sphere results in a total attenuation factor on the order of the ratio of the exit aperture area divided by the total internal sphere area.

The transmissive, in-line configuration of transmissive diffuser 124 provides lower and adjustably lower light energy attenuation as well as a more flexibly configurable overall optical measurement path. As shown, transmissive diffuser 124 comprises multiple translucent elements, such as translucent plates, including a translucent element 128. The translucent elements within transmissive diffuser 124 are axially aligned with the propagation path of light 126 generated by light source 102. Each of the translucent elements may be comprised of a non-crystalline amorphous solid material such as glass. Also, or alternatively the translucent elements of transmissive diffuser 124 may comprise polymers, liquid crystals, silicon, or other materials through which at least a portion of light 126 may propagate.

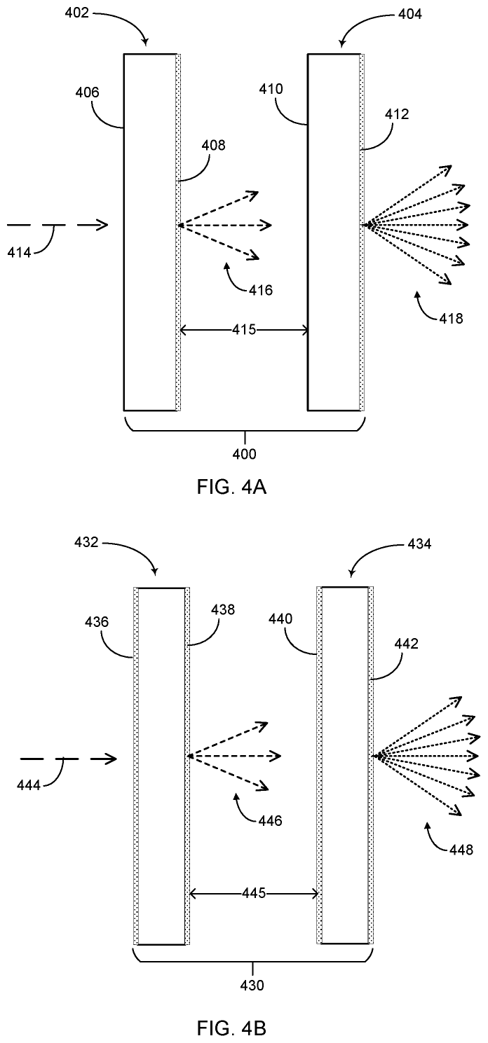

In addition to enabling light propagation via translucence, the translucent elements also include material composition and/or structural features that scatter the light 126 as it propagates through transmissive diffuser 124 to become diffused light 132. In some embodiments, the structural features that scatter the propagating light, also referred to as diffusion structures, comprises one or more scattering layers formed on one or both surfaces of each of the translucent elements. For instance, translucent element 128 may comprise a plate-like body having a substantially planar front side surface 129 and a substantially planar back side surface 130. As depicted and described in further detail with reference to FIGS. 4A and 4B, front side surface 129 and/or back side surface 130 may include diffusion structures comprising roughened surfaces that implement the light scattering function of translucent element 128. Each of the other translucent elements within transmissive diffuser 124 may similarly include roughened surfaces, such as roughened front side and/or back side surfaces, that individually and cumulatively result in diffused light 132 exiting transmissive diffuser 124. A lens 134 may be deployed at or proximate to an input port of wavelength selection device 122 to focus or otherwise intensify the light energy within diffused light 132.

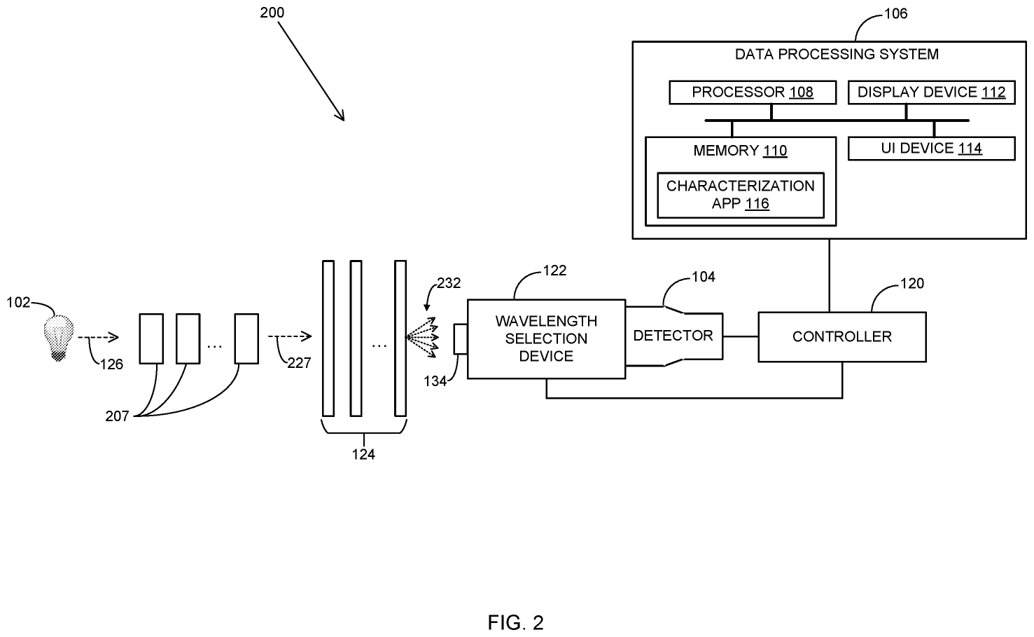

FIG. 2 is a block diagram depicting a radiometry system 200 in accordance with some embodiments. The functions and operations of components and systems described with reference to FIG. 1 may be implemented by corresponding components and systems depicted in FIG. 2. Radiometry system 200 includes sub-systems, devices, and components configured to implement characterization and related calibration techniques applicable to components and systems that implement EM radiation measurement operations. Radiometry system 200 includes an optical train beginning with light source 102 and ending with optical detector 104 that is utilized to determine and compare performance metrics for various sub-sets of an optical system that may include light source 102 and/or optical detector 104. Radiometry system 200 also includes wavelength selection device 122 that provides wavelength selective light input to optical detector 104.

Radiometry system 200 is configured to characterize, such as by measuring performance values for, a test optical system that includes one or more optical system components 207 that form an intermediary portion of an overall optical train that begins with light source 102 and ends with detector 104. For example, optical components 207 may comprise optical components such as lenses, filters, and other types of optical components through which light propagates in a field optical system. In this manner, light 126 may be modified in some ways to become a light 227 from the end of the series of optical system components 207. Radiometry system 200 may perform a sequence of optical response and other measurements that are utilized to quantify individual and/or combined performance of one or more test components. During and/or following optical measurement cycles, detector response information from optical detector 104 is processed by data processing system 206 to determine and compare performance metrics of various subsets of an overall optical system comprising optical system components 207 as well as light source 202 and optical detector 204.

In the depicted embodiment, the optical train of radiometric calibration system 200 includes an in-line, transmission-based optical diffusion component in the form of transmissive diffuser 124. Transmissive diffuser 124 is configured to include one or more transmissive scattering boundaries through which light 227 propagates toward optical detector 104. The diffusion path is in alignment with the original propagation direction of the light 126 in the depicted configuration in which light source 102, transmissive diffuser 124, and optical detector 104 are axially aligned. In some embodiments, such as during operation of radiometry system 200, scattering and diffusion of light 227 may be achieved by material composition and other structural aspects of transmissive diffuser 124 that results in light 227 being scattered while propagating through transmissive diffuser 124.

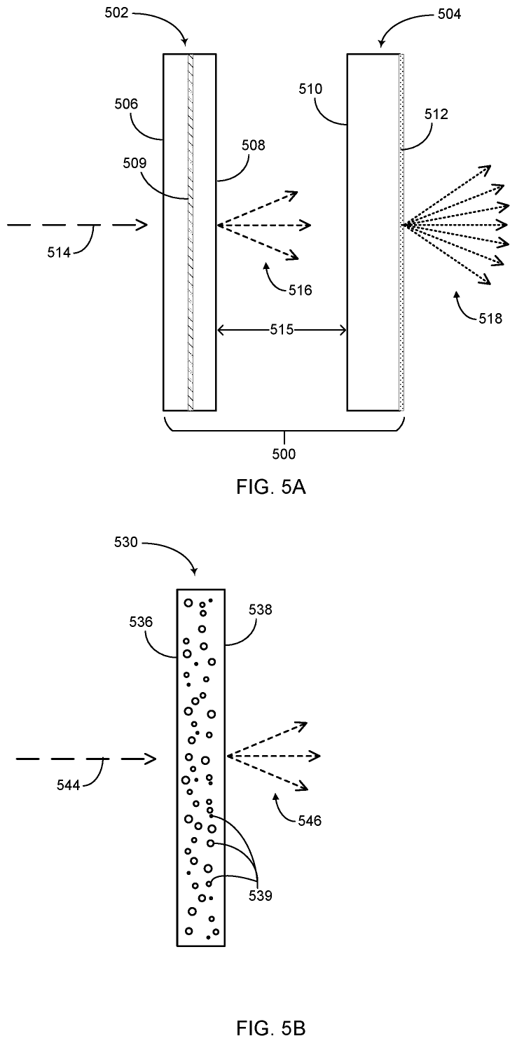

The transmissive, in-line configuration of transmissive diffuser 124 provides lower and adjustably lower light energy attenuation as well as a more flexibly configurable overall optical measurement path. As shown, transmissive diffuser 124 comprises multiple translucent elements that may be configured similarly to the translucent elements such as the translucent elements depicted in FIGS. 4A, 4B, 5A, and 5B. For example, the translucent elements within transmissive diffuser 124 may include diffusion structures comprising surface roughness layers. In alternate embodiments, translucent elements within either transmissive diffuser 124 may comprise diffusion structures that are internal to the bodies of each of the one or more translucent elements. For instance, the diffusion structures may comprise particulates disposed at random positions within the material matrix of each of the translucent elements. To implement adequate diffusion of incoming or partially diffused light, the particulates may be randomly sized as well as randomly positioned and are composed of one or more translucent materials each having a different index of refraction than the matrix material within which the particulates are suspended.

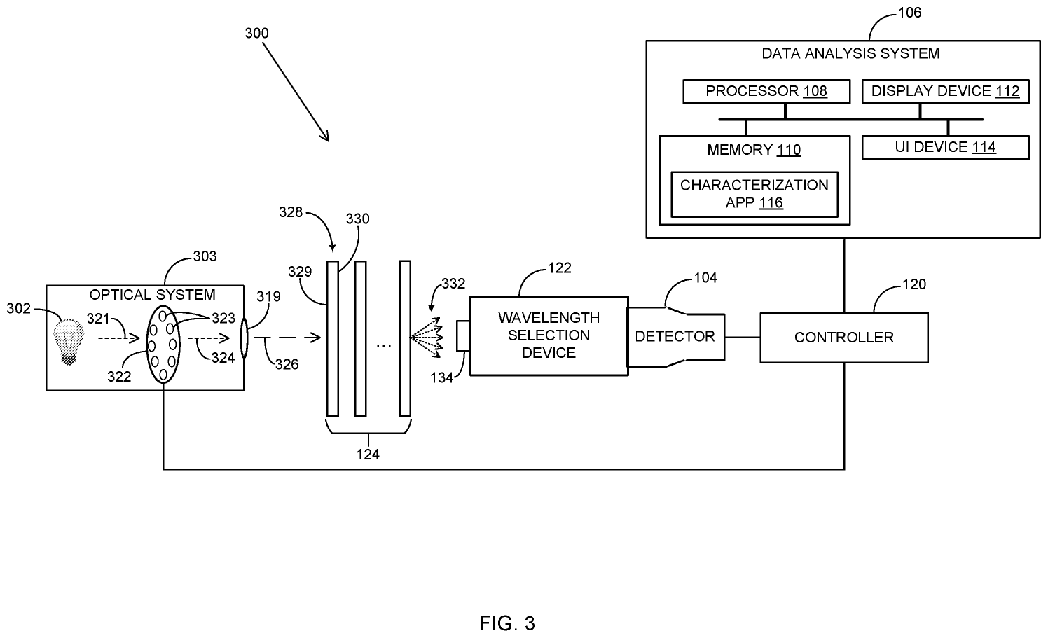

FIG. 3 is a block diagram depicting a radiometry system 300 in accordance with some embodiments. Radiometry system 300 includes sub-systems, devices, and components configured to implement calibration techniques for components and systems that implement field EM radiation measurement operations such as may be utilized for optical analysis. The optical train within radiometry system 300 includes an optical system 303 within which a non-characterized light source 302 is deployed. Light source 302 may comprise a broad-spectrum or narrow-spectrum source that generates source light 321 in the visible, infrared, and/or ultraviolet spectra ranges. Example implementations of light source 302 include electroluminescence sources such as an electroluminescent lamp, laser, LED, etc.

Optical system 303 may include components configured to circulate one or more reference fluids with different chemical compositions and properties (e.g., methane concentration, aromatics concentration, saturates concentration, Gas-Oil-Ratio—GOR—, and the like) through an optic cell 319 over widely varying calibration conditions of temperature, pressure, and density. For example, optical system 303 may comprise a high-pressure high-temperature (HPHT) test cell that includes components for circulating fluids and for varying internal pressure and temperature to simulate downhole conditions, for example. Optical system 303 may include an optical pressure-volume-temperature (PVT) instrument, and the fluids circulated within optical system 303 may include fluids commonly sampled and retrieved in downhole applications. Optical system 303 may vary each fluid over several set points spanning varying operating conditions utilizing various components such as a fluid charging system and temperature and pressure control systems.

Optic cell 319 is fluidly coupled to the fluid charging system (not depicted) within HPHT test cell 303 to allow the fluids to flow therethrough. Optical system characterization may be performed without or with fluid circulating through optic cell 319. With or without a fluid circulating through optic cell 319, light source 302 emits EM radiation that passes through optic cell 319 and any reference fluid flowing therethrough. As the EM radiation passes through optic cell 319, it exits as partially diffused light 326. For embodiments in which fluid is not pumped into optical system 303 and through optic cell 319, the light 326 interacts (e.g., refracts, reflects) with the components within optical system 303. For embodiments in which fluid is pumped into optical system 303 and through optic cell 319, the light 326 optically interacts with the components and fluid, resulting in directed, non-diffused light or partially diffused light.

Among the components within optical system 303 may be one or more optical sensors 323 that may be configured to perform a unitary or multivariate spectral processing function. Optical sensors 323 may be arranged or otherwise disposed on a sensor wheel 322 that is configured to rotate to selectively position individual ones of optical sensors 323 in the optical measurement path. Each of optical sensors 323 may include, without limitation, an optical band-pass filter or a multivariate optical sensing element deployed within a sensor wheel 322. Controller 120 may be configured to determine motion of sensor wheel so that one or more of optical sensors 323 are aligned to be within the primary light propagation path. In this manner, the aligned optical sensor contributes to interaction with the source light 321 to generate optically interacted light 324. The spectral output comprises light energy components within a spectral range determined in accordance with the design and configuration the one of sensors 323 through which the light propagates.

The optical train of radiometry system 300 further includes an in-line, transmission-based diffusion component in the form of transmissive diffuser 124 deployed between optical system 303 and wavelength selection device 122. Transmissive diffuser 124 is configured to include one or more transmissive scattering boundaries through which output light 326 is diffused as it propagates toward optical detector 304 in alignment with the original propagation direction and coherence of the output light 326. For implementations in which optical cell 303 is a high-pressure high-temperature (HPHT) test cell in which sample materials such as reference fluids are circulated through optic cell 319, output light 326 may comprise sample-interacted light in which wavelength, amplitude, and other properties of output light 326 are determined, in part, by the properties (e.g., composition, temperature, pressure) of the reference fluid through which the optically interacted light 324 passes. In some embodiments such as during operation of radiometry system 300, substantial scattering of output light 326 may be achieved by material composition and other structural aspects of transmissive diffuser 124 that results in sample-interacted light 326 being scattered while propagating through transmissive diffuser 124.

Transmissive diffuser 124 comprises one or more translucent elements having respective diffusion structures. For example, the translucent elements within transmissive diffuser 124 may include diffusion structures comprising roughened surface(s). In alternate embodiments, translucent elements within either transmissive diffuser 124 may comprise diffusion structures that are internal to the bodies of each of the one or more translucent elements. For instance, the diffusion structures may comprise particulates disposed at random positions within the material matrix of each of the translucent elements. To implement adequate diffusion of incoming non-diffused or partially diffused light, the particulates may be randomly sized as well as randomly positioned and are composed of one or more translucent materials each having a different index of refraction than the matrix material within which the particulates are suspended.

FIG. 4A illustrates a transmission-based optical diffuser in the form of a transmissive diffuser 400 that may be implemented as transmissive diffuser 124 in one or more of the radiometry systems depicted in FIGS. 1, 2, and 3 in accordance with some embodiments. Transmissive diffuser 400 comprises a first translucent element 402 and a second translucent element 404 that each comprise material, such as glass, formed as substantially plate-like material layers. Translucent element 402 includes a front side surface 406 and a back side surface 408 each of which are substantially planar. The front side surface 406 is substantially smooth and therefore a light 414, while possibly moderately refracted, is not substantially scattered as it propagates into and through front side surface 406. The back side surface 408 is a diffusion structure comprising a substantially planar surface that is roughened, comprising relatively small surface irregularities such as may be implemented by mechanical and/or chemical roughening procedures.

The light 414 continues propagating through translucent element 402 until reaching back side surface 408 at which the light is scattered by surface irregularities, resulting in release of initially diffused light 416. The initially diffused light 416 radiates in a diffused manner over a distance 415 to a front side surface 410 of translucent element 404. In some embodiments, distance 415 comprises a distance of between and including 0.5 and 1.5 inches. Front side surface 410, like the front side surface 406 of translucent element 402 is substantially smooth. Therefore, the incident initially diffused light 416 is not substantially scattered as it reaches and passes through front side surface 410. The initially diffused light 416 continues propagating through translucent element 404 until reaching a back side surface 412, that like back side surface 408 is a diffusion structure comprising a substantially planar surface having a roughness level sufficient to substantially scatter the initially diffused light 416, resulting in release of secondarily diffused light 418.

FIG. 4B depicts a transmission-based transmissive diffuser 430 that may be utilized in radiometry systems such as the radiometry systems depicted in FIGS. 1, 2, and 3 in accordance with some embodiments. Transmissive diffuser 430 comprises a first translucent element 432 and a second translucent element 434 that each comprise material, such as glass, formed as substantially plate-like material layers. Translucent element 432 includes a front side surface 436 and a back side surface 438 each of which are substantially planar. Both the front side surface 436 and back side surface 438 of translucent element 432 comprise substantially roughened planar surfaces such as may be produced by applying mechanical and/or chemical roughening procedures to produce surface irregularities. An incident light 444 is therefore scattered as it reaches and passes through each of the roughened surface boundaries formed by front side surface 436 and back side surface 438, resulting in diffused light 446 radiating in a diffused manner across a distance 445 to translucent element 434. In some embodiments, distance 445 comprises a distance of between and including 0.5 and 1.5 inches. Both a front side surface 440 and a back side surface 442 of translucent element 434 comprise substantially roughened planar surfaces. Therefore, the incident diffused light 446 is substantially scattered as it reaches and passes through each of the roughened surface boundaries formed by front side surface 440 and back side surface 442, resulting in further diffused light 448 radiating from transmissive diffuser 430.

In some embodiments, a radiometry system may include a transmissive diffuser having alternative surface diffusion structures such as surface coating of translucent or semi-translucent material. A radiometry system may also or alternatively implement a transmissive diffuser having internal diffusion structures. For example, FIG. 5A illustrates a transmission-based optical diffuser in the form of a transmissive diffuser 500 that may be utilized in radiometry systems such as the radiometry systems depicted in FIGS. 1, 2, and 3 in accordance with some embodiments. Transmissive diffuser 500 comprises a first translucent element 502 and a second translucent element 504 that each comprise material, such as glass, formed as substantially plate-like material layers. In contrast to the translucent element configurations shown in FIGS. 4A and 4B, translucent element 502 includes an internal diffusion structure in the form of a diffusion material layer 509 within the body of translucent element 502. A light 514, while possibly moderately refracted, is not substantially scattered as it propagates into and through a front side surface 506.

The light 514 continues propagating through translucent element 502 until reaching diffusion material layer 509 at which the light is scattered, resulting in release of initially diffused light 516 through the back side 508. The initially diffused light 516 radiates in a diffused manner over a distance 515 to a front side surface 510 of translucent element 504. In some embodiments, a distance 515 between back side 508 and a front side 510 of translucent element 504 comprises a distance of between and including 0.5 and 1.5 inches. Front side surface 510, like the front side surface 506 of translucent element 502 is substantially smooth. Therefore, the incident initially diffused light 516 is not substantially scattered as it reaches and passes through front side surface 510. The initially diffused light 516 continues propagating through translucent element 504 until reaching a roughened back side surface 512 that scatters the initially diffused light 516, resulting in release of secondarily diffused light 518.

FIG. 5B illustrates a transmission-based optical diffuser in the form of a transmissive diffuser 530 that may be utilized in radiometry systems such as the radiometry systems depicted in FIGS. 1, 2, and 3 in accordance with some embodiments. Transmissive diffuser 530 comprises a single translucent element that like translucent element 502 includes an internal diffusion structure. The translucent element comprises a first matrix material, such as glass, formed as substantially plate-like body member. An internal diffusion structure is disposed within the translucent element in the form of multiple particulates 539 that may be randomly distributed throughout the matrix material volume of transmissive diffuser 530. In some embodiments, particulates 539 may comprise differently sized particulates comprising a material that is translucent to the wavelengths of light to be detected and having a different index of refraction than the matrix material of translucent element 530 in which particulates 539 are suspended. A light 544, while possibly moderately refracted, is not substantially scattered as it propagates into and through a front side surface 536. As light 544 propagates into and through transmissive diffuser 530, light 544 is scattered, resulting in release of diffused light 546 through the back side 508.

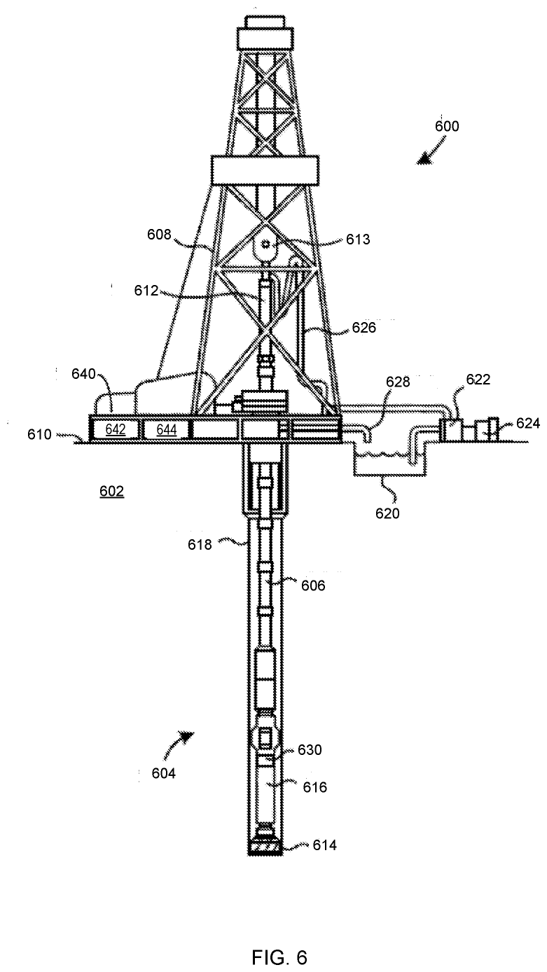

FIG. 6 illustrates a drilling system 600 in accordance with some embodiments. Drilling system 600 is configured to including and use optical components for measuring properties of downhole material such as downhole fluids for example to determine the chemical composition or other composition aspects of the downhole materials. The resultant downhole material properties information may be utilized for various purposes such as for modifying a drilling parameter or configuration, such as penetration rate or drilling direction, in a measurement-while-drilling (MWD) and a logging-while-drilling (LWD) operation. Drilling system 600 may be configured to drive a bottom hole assembly (BHA) 604 positioned or otherwise arranged at the bottom of a drill string 606 extended into the earth 602 from a derrick 608 arranged at the surface 610. Derrick 608 may include a kelly 612 and a traveling block 613 used to lower and raise kelly 612 and drill string 606.

BHA 604 may include a drill bit 614 operatively coupled to a tool string 616 that may be moved axially within a drilled wellbore 618 as attached to the drill string 606. During operation, drill bit 614 penetrates the earth 602 and thereby creates wellbore 618. BHA 604 may provide directional control of drill bit 614 as it advances into the earth 602. Tool string 616 can be semi-permanently mounted with various measurement tools (not shown) such as, but not limited to, MWD and LWD tools, that may be configured to perform downhole measurements of downhole conditions. In some embodiments, the measurement tools may be self-contained within tool string 616, as shown in FIG. 6.

Drilling fluid from a drilling fluid tank 620 may be pumped downhole using a pump 622 powered by an adjacent power source, such as a prime mover or motor 624. The drilling fluid may be pumped from the tank 620, through a stand pipe 626, which feeds the drilling fluid into drill string 606 and conveys the same to drill bit 614. The drilling fluid exits one or more nozzles arranged in drill bit 614 and in the process cools drill bit 614. After exiting drill bit 614, the drilling fluid circulates back to the surface 610 via the annulus defined between wellbore 618 and drill string 606, and in the process, returns drill cuttings and debris to the surface. The cuttings and mud mixture are passed through a flow line 628 and are processed such that a cleaned drilling fluid is returned down hole through stand pipe 626.

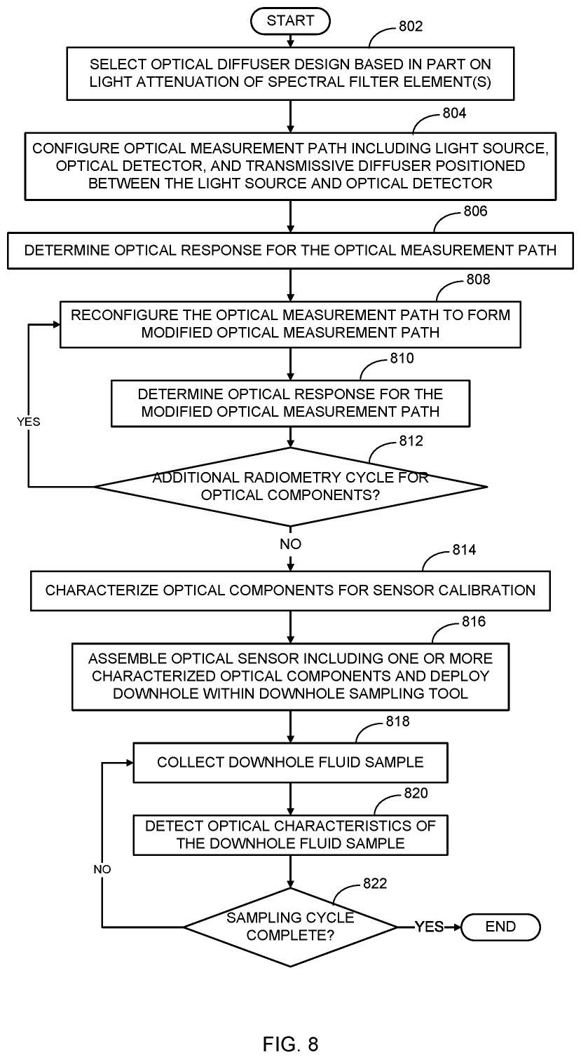

Tool string 616 may further include a downhole tool 630 similar to the downhole tools described herein. More particularly, downhole tool 630 may have a calibrated optical sensor comprising optical components arranged therein, and the downhole tool 630 may have been calibrated or otherwise characterized prior to being introduced into the wellbore 618 using the radiometric characterization testing described herein. Moreover, prior to being introduced into the wellbore 618, downhole tool 630 may have been optimized by the steps described below with reference to FIG. 8. Downhole tool 630 may be controlled from the surface 610 by a computer 640 having a memory 642 and a processor 644. Accordingly, memory 642 may store commands that, when executed by processor 644, cause computer 640 to perform at least some steps in methods consistent with the present disclosure.

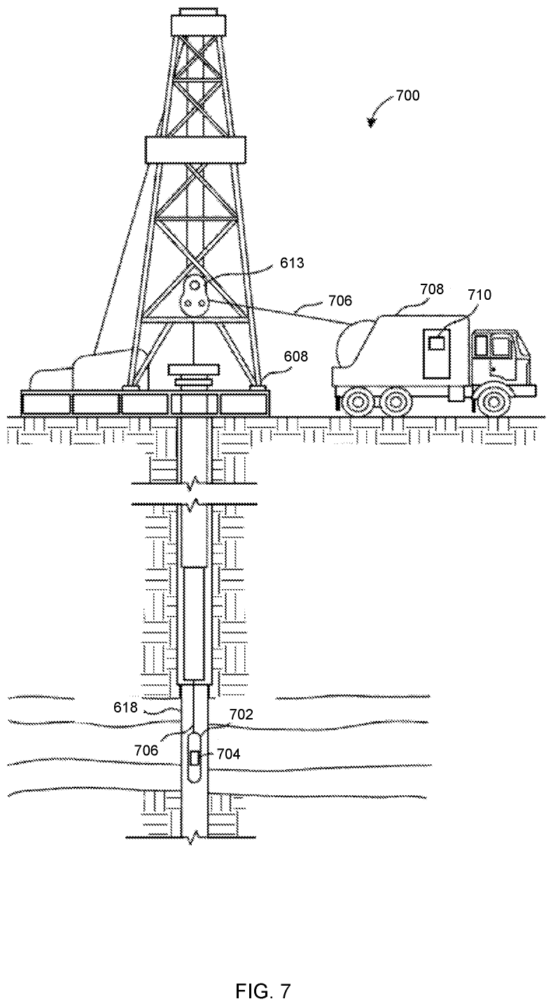

FIG. 7 illustrates a wireline system 700 that may employ one or more principles of the present disclosure. In some embodiments, wireline system 700 may be configured to use a formation tester and calibrated optical tool. After drilling of wellbore 618 is complete, it may be desirable to determine details regarding composition of formation fluids and associated properties through wireline sampling. Wireline system 700 may include a downhole tool 702 that forms part of a wireline logging operation that can include one or more optical measurement components 704, as described herein, as part of a downhole measurement tool. Wireline system 700 may include the derrick 608 that supports the traveling block 613. Wireline logging tool 702, such as a probe or sonde, may be lowered by a wireline cable 706 into wellbore 618.

Downhole tool 702 may be lowered to potential production zone or other region of interest wellbore 618 and used in conjunction with other components such as packers and pumps to perform well testing and sampling. More particularly, downhole tool 702 may include a calibrated optical sensor 704 comprising optical components arranged therein, and the optical sensor 704 may have been calibrated, including characterizing one or more of the optical components using the radiometric characterization testing described herein prior to being introduced into the wellbore 618. Moreover, prior to being introduced into the wellbore 618, downhole tool 702 including optical sensor 704 have been optimized by the steps described below with reference to FIG. 8. Optical sensor 704 may be configured to measure optical responses of the formation fluids, and any measurement data generated by downhole tool 702 and its associated optical sensor 704 can be real-time processed for decision-making, or communicated to a surface logging facility 708 for storage, processing, and/or analysis. Logging facility 708 may be provided with electronic equipment 710, including processors for various types of data and signal processing including perform at least some steps in methods consistent with the present disclosure.

FIG. 8 is a flow diagram illustrating operations and functions for characterizing optical components and utilizing the characterized optical components for downhole fluid sampling and measurements in accordance with some embodiments. The process begins as shown at block 802 with the selection of an optical diffuser design based on the types of optical components to be included in an optical measurement path. For example, variations in the optical diffuser type/design that may be selected are illustrated and described with reference to FIGS. 1, 2, 3, 4A, 4B, 5A, and 5B. The optical diffuser design may be selected such that the level of diffusion provided by the selected design varies inversely with the level of light attenuation of the optical components in the measurement path. In some embodiments, the optical diffuser design is selected based on the light attenuation characteristics of optical components that operate as spectral filter elements. The selection of an optical diffuser design may be implemented by programmed elements such as those stored and executed on data processing system 106 depicted in FIGS. 1-3.

At block 804, an optical measurement path that includes an optical diffuser having the selected design is configured. As depicted in FIGS. 1, 2, and 3, the optical measurement path may include various combinations of optical and measurement components. The combinations of possible optical and measurement components include, among other possible components, a light source, an optical detector and the optical diffuser positioned between the light source and the optical detector. At block 806, an optical response for the optical measurement path is measured or otherwise determined using the optical detector among other possible components.

At block 808, the optical measurement path is reconfigured in terms of replacing at least one of the optical or measurement components in the measurement path. For example, if the initial measurement path configured as shown at block 804 included a reference light source, the reconfiguration at block 808 may include replacing the reference light source with a field light source (i.e., a light source to be deployed in a downhole optical sensor). As shown at block 810, an optical response for the reconfigured optical measurement path is measured or otherwise determined using the optical detector among other possible components. At inquiry block 812 control passes back to block 808 if additional radiometry cycles remain to be performed.

When all radiometry cycles have been performed using one or more reconfigured optical measurement paths, control passes to block 814 that illustrates characterization of the optical field components included in one or more of the optical measurement paths. The characterizations may be used for various purposes including calibration of an optical sensor that incorporates one or more of the optical components. Such characterization and calibration operations may be implemented by programmed elements such as those stored and executed on data processing system 106 depicted in FIGS. 1-3.

At block 816, an optical sensor is assembled to include one or more of the optical devices that were characterized at blocks 802-814 and the optical sensor is deployed downhole within a downhole sampling tool. For example, the optical sensor may comprise an optical sensor deployed within optical sensor 630 in FIG. 6 or, in a wireline configuration may comprise the optical sensor 704 within the downhole tool 702 in FIG. 7. At block 818, the downhole tool collects a fluid sample, such as may be a formation fluid, to be measured or otherwise characterized at least in terms of optical properties by the optical sensor. At block 820, the optical sensor is utilized to detect the optical characteristics, such as may relate to spectral responses, of the collected downhole fluid. Programmed elements includes with the optical sensor or executed by another information processing system may be used to compute, calculate, or otherwise determine the material/chemical composition of the collected downhole fluid based on the determined optical responses/characteristics. The collection and processing of downhole fluid samples may continue with control passing from block 820 back to block 818 until the downhole fluid sampling cycle terminates.

### Example Embodiments

Embodiment 1: A radiometry system comprising: a light source that generates light; a transmissive diffuser configured to receive the light and comprising a first translucent element having a diffusion structure that scatters the light; and an optical detector configured to receive and detect diffused light from said transmissive diffuser. For Embodiment 1, said light source, said transmissive diffuser, and said optical detector may be axially aligned within a light propagation path from said light source to said optical detector. For Embodiment 1, said diffusion structure may comprise particulates dispersed within a matrix of said first translucent element comprising a first material, wherein said particles comprise a second material. For Embodiment 1, the second material may be translucent to wavelength components within the light and may have different refractive properties than the first material. For Embodiment, said diffusion structure may comprise a roughened surface of said first translucent element. For Embodiment 1, the first translucent element may comprise a material layer that is substantially translucent to wavelength components within the light, and wherein the surface roughness may be disposed on a backside surface of the first translucent element opposite a frontside surface that receives the light. For Embodiment 1, the material layer may comprise a non-crystalline amorphous solid material. For Embodiment 1, said transmissive diffuser may further comprise a second translucent element having a diffusion structure that scatters light, and wherein the first and second translucent elements are mutually configured so that initially diffused light from the first translucent element is received and further diffused by the second translucent element. For Embodiment 1, the first and second translucent elements may comprise a pair of glass plates having mutually opposing surfaces that are separated by a distance between and including 0.5 and 1.5 inches. For Embodiment 1, the first translucent element may include a first surface through which the light propagates to the diffusion structure of the first translucent element comprising a roughened second surface through which the light is scattered to generate the initially diffused light. For Embodiment 1, the second translucent element may include a first surface through which the initially diffused light propagates to a roughened second surface of the second translucent element through which the initially diffused light is further scattered to generate diffused light that propagates to the optical detector, and wherein the first surface of the second translucent element may be substantially smooth.

Embodiment 2: A radiometric characterization system comprising: an optical train comprising optical components including, a light source comprising either a characterized light source or an uncharacterized light source; a transmissive diffuser that receives light transmitted from said light source, said transmissive diffuser comprising a first translucent element having a diffusion structure that scatters the light to generate diffused light; and an optical detector comprising either a characterized optical detector or an uncharacterized optical detector, wherein said optical detector generates optical responses to the diffused light; and a characterization unit configured to determine a characterization metric for one or more of the optical components based on one or more of the optical responses. For Embodiment 2, the optical components may further comprise one or more components though which the light propagates from said light source to said transmissive diffuser. For Embodiment 2, said light source, said transmissive diffuser, and said optical detector may be axially aligned within a light propagation path from said light source to said optical detector. For Embodiment 2, the first translucent element may comprise a non-crystalline amorphous solid material that is substantially translucent to frequency components within the light. For Embodiment 2, said transmissive diffuser may further comprise a second translucent element having a diffusion structure that scatters light, and wherein the first and second translucent elements may be mutually configured so that initially diffused light from the first translucent element is received and further diffused by the second translucent element. For Embodiment 2, the first and second translucent elements may comprise a pair of glass plates having mutually opposing surfaces that are separated by a distance. For Embodiment 2, the first translucent element may include a first surface through which the light propagates to the diffusion structure of the first translucent element comprising a roughened second surface through which the light is scattered to generate the initially diffused light. For Embodiment 2, the second translucent element may include a first surface through which the initially diffused light propagates to a roughened second surface of the second translucent element through which the initially diffused light is further scattered to generate diffused light that propagates to the optical detector, and wherein the first surface of the second translucent element is substantially smooth.

Embodiment 3: A method comprising: configuring an optical measurement path that comprises optical components including a light source, an optical detector, and a transmissive diffuser positioned between the light source and the optical detector; determining an optical response for the optical measurement path; reconfiguring the optical measurement path to form one or more modified optical measurement paths in which one or more reference optical components within the optical measurement path are replaced with one or more field optical components; determining optical responses for the one or more modified optical measurement paths; and characterizing one or more optical field components in the optical measurement path or modified optical measurement paths based, at least in part, on the one or more of the optical response for the optical measurement path and the one or more modified optical measurement paths. For Embodiment 3, the transmissive diffuser may be configured to receive light originating from the light source and may comprise: a first translucent element having a front surface through which the light propagates to a roughened back surface of the first translucent element through which the light is scattered to generate initially diffused light; and a second translucent element having a front surface through which the initially diffused light propagates to a roughened second surface of the second translucent element through which the initially diffused light is further scattered to generate diffused light. For Embodiment 3, the method may further comprise: incorporating one or more of the characterized optical field components in an optical sensor deployed in a downhole tool; collecting, using the downhole tool, a downhole fluid sample; and detecting, using the optical sensor, optical characteristics of the downhole fluid sample. For Embodiment 3, the method may further comprise determining composition characteristics of the downhole fluid sample based on the detected optical characteristics.

What is claimed is:

1. A radiometry system comprising:
a light source that generates light;
a transmissive diffuser configured to receive the light and comprising a first translucent element having a diffusion structure that scatters the light; and
an optical detector configured to receive and detect diffused light from said transmissive diffuser.

2. The radiometry system of claim 1, wherein said light source, said transmissive diffuser, and said optical detector are axially aligned within a light propagation path from said light source to said optical detector.

3. The radiometry system of claim 1, wherein said diffusion structure comprises particulates dispersed within a matrix of said first translucent element comprising a first material, wherein said particulates comprise a second material.

4. The radiometry system of claim 3, wherein the second material is translucent to wavelength components within the light and has different refractive properties than the first material.

5. The radiometry system of claim 1, wherein said diffusion structure comprises a roughened surface of said first translucent element.

6. The radiometry system of claim 5, wherein the first translucent element comprises a material layer that is substantially translucent to wavelength components within the light, and wherein the surface roughness is disposed on a backside surface of the first translucent element opposite a frontside surface that receives the light.

7. The radiometry system of claim 6, wherein the material layer comprises a non-crystalline amorphous solid material.

8. The radiometry system of claim 1, wherein said transmissive diffuser further comprises a second translucent element having a diffusion structure that scatters light, and wherein the first and second translucent elements are mutually configured so that initially diffused light from the first translucent element is received and further diffused by the second translucent element.

9. The radiometry system of claim 8, wherein the first and second translucent elements comprise a pair of glass plates having mutually opposing surfaces that are separated by a distance between and including 0.5 and 1.5 inches.

10. The radiometry system of claim 8, wherein the first translucent element includes a first surface through which the light propagates to the diffusion structure of the first translucent element comprising a roughened second surface through which the light is scattered to generate the initially diffused light.

11. The radiometry system of claim 10, wherein the second translucent element includes a first surface through which the initially diffused light propagates to a roughened second surface of the second translucent element through which the initially diffused light is further scattered to generate diffused light that propagates to the optical detector, and wherein the first surface of the second translucent element is substantially smooth.

12. A radiometric characterization system comprising:
an optical train comprising optical components including:
a light source comprising either a characterized light source or an uncharacterized light source;
a transmissive diffuser that receives light transmitted from said light source, said transmissive diffuser comprising a first translucent element having a diffusion structure that scatters the light to generate diffused light; and
an optical detector comprising either a characterized optical detector or an uncharacterized optical detector, wherein said optical detector generates optical responses to the diffused light; and
a characterization unit configured to determine a characterization metric for one or more of the optical components based on one or more of the optical responses.

13. The radiometric characterization system of claim 12, wherein the optical components further comprise one or more components though which the light propagates from said light source to said transmissive diffuser.

14. The radiometric characterization system of claim 12, wherein said transmissive diffuser further comprises a second translucent element having a diffusion structure that scatters light, and wherein the first and second translucent elements are mutually configured so that initially diffused light from the first translucent element is received and further diffused by the second translucent element.

15. The radiometric characterization system of claim 14, wherein the first and second translucent elements comprise a pair of glass plates having mutually opposing surfaces that are separated by a distance.

16. The radiometric characterization system of claim 14, wherein the first translucent element includes a first surface through which the light propagates to the diffusion structure of the first translucent element comprising a roughened second surface through which the light is scattered to generate the initially diffused light, and wherein the second translucent element includes a first surface through which the initially diffused light propagates to a roughened second surface of the second translucent element through which the initially diffused light is further scattered to generate diffused light that propagates to the optical detector, and wherein the first surface of the second translucent element is substantially smooth.

17. A method comprising:
configuring an optical measurement path that comprises optical components including a light source, an optical detector, and a transmissive diffuser positioned between the light source and the optical detector;
determining an optical response for the optical measurement path;
reconfiguring the optical measurement path to form one or more modified optical measurement paths in which one or more reference optical components within the optical measurement path are replaced with one or more field optical components;
determining optical responses for the one or more modified optical measurement paths; and
characterizing one or more optical field components in the optical measurement path or modified optical measurement paths based, at least in part, on the one or more of the optical response for the optical measurement path and the one or more modified optical measurement paths.

18. The method of claim 17, wherein the transmissive diffuser is configured to receive light originating from the light source and comprises:
a first translucent element having a front surface through which the light propagates to a roughened back surface of the first translucent element through which the light is scattered to generate initially diffused light; and
a second translucent element having a front surface through which the initially diffused light propagates to a roughened second surface of the second translucent element through which the initially diffused light is further scattered to generate diffused light.

19. The method of claim 17, further comprising:
incorporating one or more of the characterized optical field components in an optical sensor deployed in a downhole tool;
collecting, using the downhole tool, a downhole fluid sample; and
detecting, using the optical sensor, optical characteristics of the downhole fluid sample.

20. The method of claim 19, further comprising determining composition characteristics of the downhole fluid sample based on the detected optical characteristics.
